(19) United States
(12) Patent Application Publication
(10) Pub. No.: US 2012/0266446 A1
(43) Pub. Date: Oct. 25, 2012

(54) TOILET SEAT FASTENING SYSTEM

(76) Inventor: Michael R. Leibfried, Lancaster, WI (US)

(21) Appl. No.: 13/452,360

(22) Filed: Apr. 20, 2012

Related U.S. Application Data
(60) Provisional application No. 61/478,249, filed on Apr. 22, 2011.

(51) Int. Cl. A47K 13/26; F16B 39/04; B23P 11/00

(52) U.S. Cl. 29/525.02; 4/237; 411/295

(57) ABSTRACT

A mounting apparatus for coupling a toilet seat hinge to a toilet flange includes a bolt with a proximal end including an upper flange and threaded distal end, a nut with a threaded opening that receives the threaded distal end of the bolt and a plurality of radial openings, and a set screw. The radial openings extend from a first end proximate to the threaded opening to a second end on the outer periphery of the nut. The set screw is received in one of the radial openings. The set screw provides a pressure to the threaded distal end of the bolt.

### CROSS REFERENCE TO RELATED APPLICATIONS

This application claims priority to U.S. Provisional Application No. 61/478,249, filed: Apr. 22, 2011, which is hereby incorporated by reference in its entirety.

### FIELD

The present technology relates generally to the field of mounting apparatuses for toilet seats, and in particular, toilet seat mounting devices that include a deformable bushing or grommet and a set screw.

### BACKGROUND

Toilet seats are typically mounted to a toilet with a bolt and nut. The bolt extends through an opening in the toilet bowl flange and engages a nut on the other side. The opening in the toilet bowl flange is typically larger than the diameter of the bolt and the toilet seat is held in place by the clamping force between the bolt and the nut. Over time, as the bolt loosens, the toilet seat may begin to slide and shift due to the space or “play” between the bolt and the opening.

It would be advantageous to provide an improved apparatus for mounting a toilet seat to a toilet that reduces the likelihood that the toilet seat will loosen over time.

### SUMMARY

In one aspect, a mounting apparatus is provided for coupling a toilet seat hinge to a toilet flange. The mounting apparatus includes a bolt with a proximal end comprising an upper flange and threaded distal end, a nut with a threaded opening that receives the threaded distal end of the bolt and a plurality of radial openings, and a set screw. The radial openings extend from a first end proximate to the threaded opening to a second end on the outer periphery of the nut. The set screw is received in one of the radial openings. The set screw contacts the threaded distal end of the bolt.

In another aspect, a mounting apparatus is provided for coupling a toilet seat hinge to a toilet flange. The mounting apparatus includes a bolt with a proximal end including an upper flange and a threaded distal end, a nut with a threaded opening, and a bushing disposed in an opening in the toilet flange. The bushing forms an interference fit with the toilet flange.

In another aspect, a method is provided for coupling a toilet seat hinge to a toilet flange with an aperture. The method includes providing a bolt on one side of the toilet flange such that the bolt extends through the aperture and providing a nut on the side of the toilet flange opposite of the bolt. The bolt includes a threaded end. The nut includes at least one opening for a set screw. The method further includes engaging the nut with the bolt such that toilet seat hinge is between the bolt and the toilet flange and providing a set screw in the opening. The set screw provides a pressure on the threaded end of the bolt. The method may further include providing a bushing in an opening in the toilet flange and forming an interference fit between the bushing and the toilet flange by tightening the nut to deform the bushing

It is to be understood that both the foregoing general description and the following detailed description are illustrative and explanatory only, and are not restrictive of the invention as claimed.

### BRIEF DESCRIPTION OF THE DRAWINGS

These and other features, aspects, and advantages of the present invention will become apparent from the following description, appended claims, and the accompanying illustrative embodiments shown in the drawings, which are briefly described below.

FIG. 1 is an exploded view of an apparatus for coupling a toilet seat hinge to a toilet, according to an illustrative embodiment.

FIG. 2A is an isometric view of a deformable bushing for the apparatus of FIG. 1, according to another illustrative embodiment.

FIG. 2B is a side view of the bushing of FIG. 2A.

FIG. 2C is an isometric view of a deformable bushing for the apparatus of FIG. 1, according to another illustrative embodiment.

FIG. 2D is a side view of the bushing of FIG. 2C.

FIG. 2E is an isometric view of a deformable bushing for the apparatus of FIG. 1, according to another illustrative embodiment.

FIG. 2F is a cross section of the bushing of FIG. 2E.

FIG. 3 is an exploded view of an apparatus for coupling a toilet seat hinge to a toilet, according to another illustrative embodiment.

FIG. 4 is a cross section of the apparatus of FIG. 3 taken along line 4-4.

FIG. 5 is an exploded view of an apparatus for coupling a toilet seat hinge to a toilet, according to another illustrative embodiment.

FIG. 6 is a cross section of the apparatus of FIG. 3 taken along line 6-6.

FIG. 7 is a schematic cross section of the apparatus hinge of FIG. 5 showing different profiles, according to various illustrative embodiments.

FIG. 8 is an exploded view of an apparatus for coupling a toilet seat hinge to a toilet, according to another illustrative embodiment.

FIG. 9A-9C are cross sections of the apparatus hinge of FIG. 8 taken along line 9-9, showing different profiles according to several illustrative embodiments.

FIG. 10 is an exploded view of an apparatus for coupling a toilet seat hinge to a toilet including a nut with an integrally formed bushing member, according to another illustrative embodiment.

FIGS. 11A-11D are isometric views of a nut of the apparatus of FIG. 10, according to several illustrative embodiment.

FIG. 12 is a cross-section of the nut of FIG. 11D shown coupled to a toilet bowl flange, according to an illustrative embodiment.

FIGS. 13A-13E are isometric views of a nut with openings for a set screw, according to several illustrative embodiments.

FIGS. 14A-14C are isometric views of a wrench including frangible portions for installing an apparatus for coupling a toilet seat hinge to a toilet, according to several illustrative embodiments.

FIGS. 15A-15D are isometric views of a wrench head with frangible portions being driven with various devices, according to several illustrative embodiments.

FIG. 16 is an isometric view of a toilet showing a nut of FIGS. 13A-13E being used in several locations, according to an illustrative embodiment.

FIG. 17 is an isometric view of a nut with a set screw for coupling a toilet tank to a toilet bowl, according to an illustrative embodiment.

FIG. 18 is an isometric view of a nut with a set screw for coupling a toilet bowl to a floor, according to an illustrative embodiment.

FIG. 19 is a cross-section of the nut of FIG. 18, taken along line 19-19.

### DETAILED DESCRIPTION

Referring generally to the figures, a mounting apparatus configured to couple a hinge for a toilet seat to a toilet is shown. In one embodiment, the mounting apparatus includes a bolt, a nut, and a bushing member provided in the opening in the toilet bowl flange. As the bolt and the nut are tightened, they compress the bushing member, causing it to increase in diameter and fill the opening in the toilet bowl flange. This increases the stability of the toilet seat and reduces the likelihood that it will loosen over time. In another embodiment, the mounting apparatus includes a bolt, a nut, and a set screw that is received in an opening in the nut. After the bolt has been tightened to secure the toilet seat to the toilet, the set screw is tightened until it contacts the threaded portion of the bolt. This contact restricts the motion of the nut and reduces the likelihood that it will back off of the bolt over time. The toilet seat mounting apparatus may be used in residential or commercial restrooms.

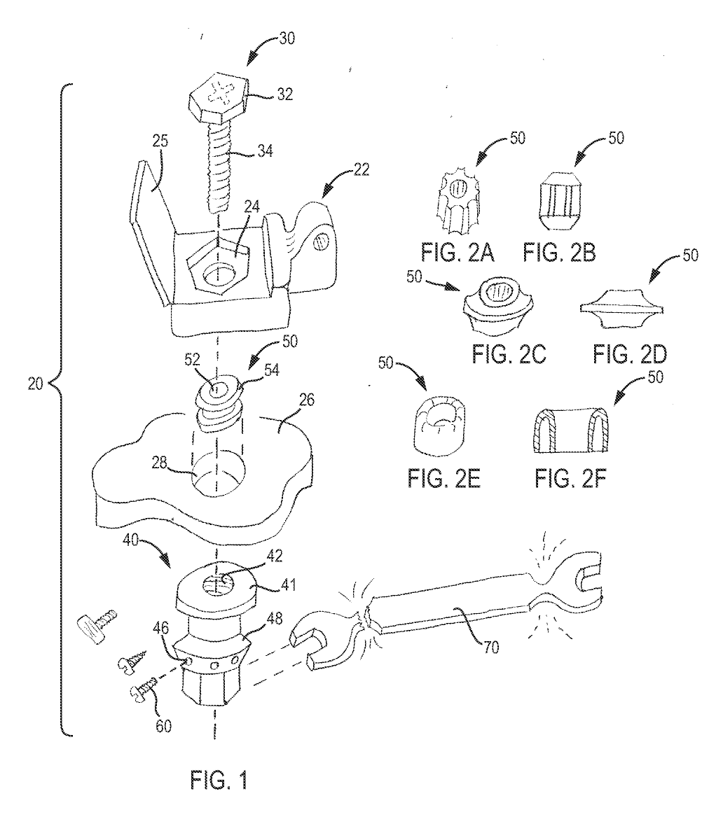

Referring to FIG. 1, a mounting apparatus 20 is shown, according to an illustrative embodiment. The mounting apparatus 20 couples a hinge 22 for a toilet seat to a toilet bowl flange 26. The flange 26 extends inwardly around the rim of the bowl of the toilet and includes at least one aperture 28.

The apparatus 20 includes a bolt 30, a nut 40, a bushing 50, and a set screw 60. The bolt 30 is received within the aperture 28. The bolt 30 is a threaded member that engages the threaded nut 40 provided on the opposite side of the flange 26. The bushing 50 is received in the aperture 28. Through the interconnection of the bolt 30, the hinge 22, and the nut 40, the toilet seat may be coupled to toilet bowl flange 26.

The bolt 30 includes an upper portion with an upper flange 32 and a threaded end 34. The aperture 28 has a diameter that is larger than the threaded end 34 of the bolt 30, but smaller than the diameter of the upper flange 32. The upper flange 32 of the bolt 30 may be received in a recess 24 in the hinge 22. A cover 25 may be provided to conceal the upper flange 32.

The nut 40 includes an upper flange 41 and a threaded opening 42 that is configured to receive the threaded end 34 of the bolt 30. Once engaged with the bolt 30, the nut 40 may be tightened to advance threaded end 34 in threaded opening 42. The nut may be tightened using a wrench 70, described below. After being tightened, the set screw 60 may be coupled to the nut 40.

The bushing 50 is a deformable member with a central opening 52 through which the threaded end 34 of the bolt 30 may pass. According to various embodiments, the bushing 50 may be formed of a resilient material (e.g., rubber, latex, etc.) or may be a rigid material such as a polymer (e.g., nylon, polypropylene, poly ethylene, etc.).

Referring in general to FIGS. 1-7, according to several illustrative embodiments, the bushing 50 may be a separate element. The bushing 50 is sized such that it may be placed in the aperture 28 and may have a diameter slightly smaller than the diameter if the aperture 28. The advancement of the bolt 30 compresses the bushing 50 between the hinge 22 and the upper flange 41 of the nut 40. The compression causes the diameter of the bushing 50 to increase, forcing at least a portion of the outer periphery 54 of the bushing 50 to contact the flange 26 around the aperture 28 and form an interference fit between the bushing 50 and the toilet bowl flange 26. This eliminates the gap that is exists between the threaded end 34 of the bolt 30 and the outer diameter of the aperture 28. The compressed bushing 50 therefore eliminates most or all of the “play” for the toilet seat that may otherwise develop as the threaded connection between the bolt 30 and the nut 40 loosens. Axis 4 generally defines the arrangement of the above components.

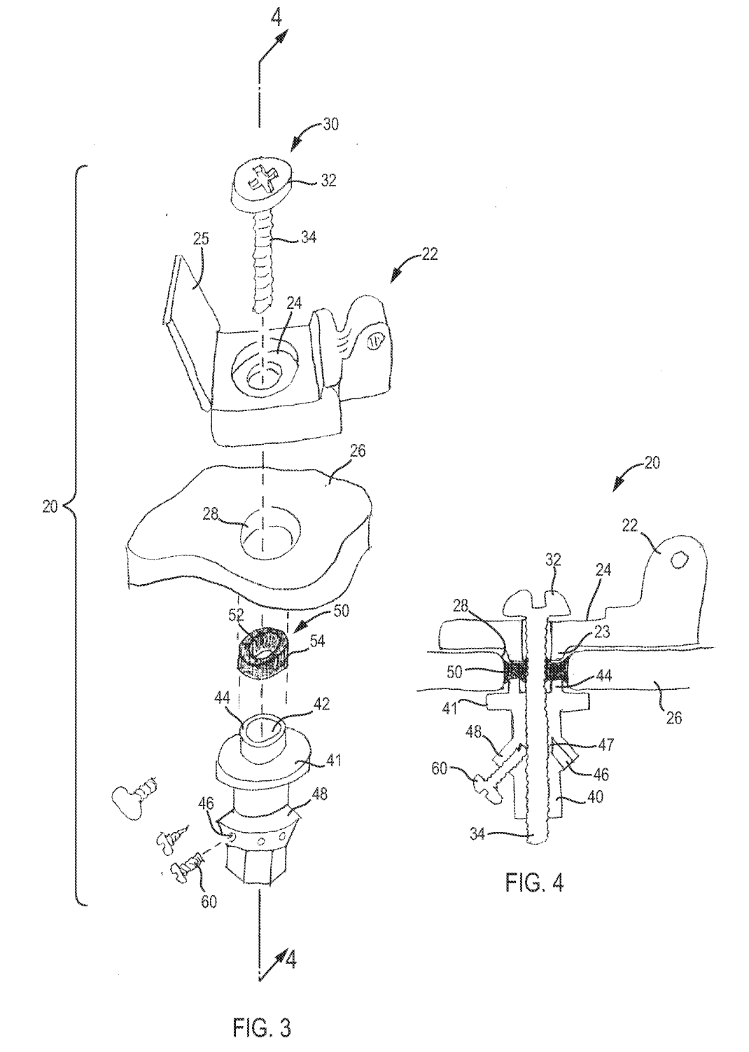

Referring to FIGS. 3-4, according to another illustrative embodiment, the nut 40 may include a projection 44 (e.g., ring, ridge, extension, collar, etc.) that extends from the upper flange 41. The projection 44 surrounds the threaded opening 42 and has a diameter less than the diameter of the aperture 28. As the threaded connection between the bolt 30 and the nut 40 is tightened, the projection 44 is received in the aperture 28 to compress the bushing 50. The hinge 22 may include a corresponding projection 23 that extends downward into the aperture 28 to compress the bushing 50.

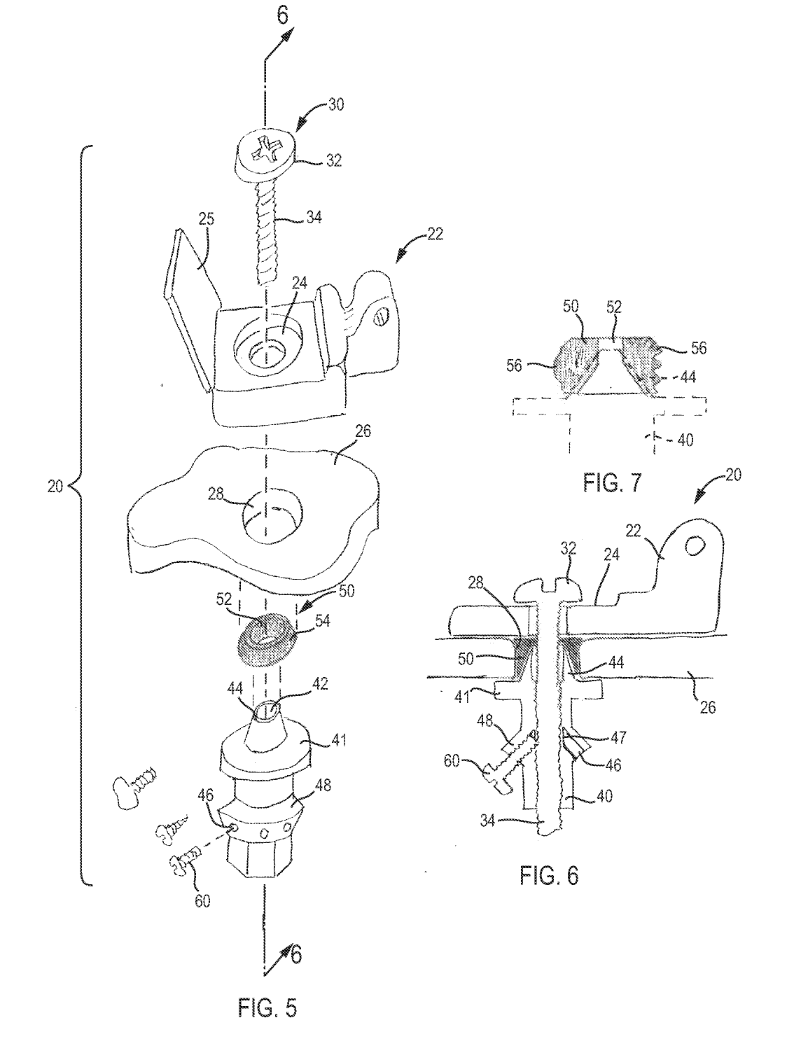

Referring now to FIGS. 5-7, according to another illustrative embodiment, the projection 44 of the nut 40 may nest inside the bushing 50 to compress it outward instead of compressing it in a vertical direction, as shown in FIGS. 3-4. The projection 44 may have an inclined, cone-shaped outer surface that is received in a similarly shaped central opening 52 of the bushing 50. As the threaded connection between the bolt 30 and the nut 40 is tightened, the projection 44 is received in the central opening 52 and forces the bushing 50 to expand outward. Axis 6 generally defines the arrangement of the above components. Referring to FIG. 7, according to various illustrative embodiments, the bushing 50 may include one or more ridges 56 about the outer periphery 54.

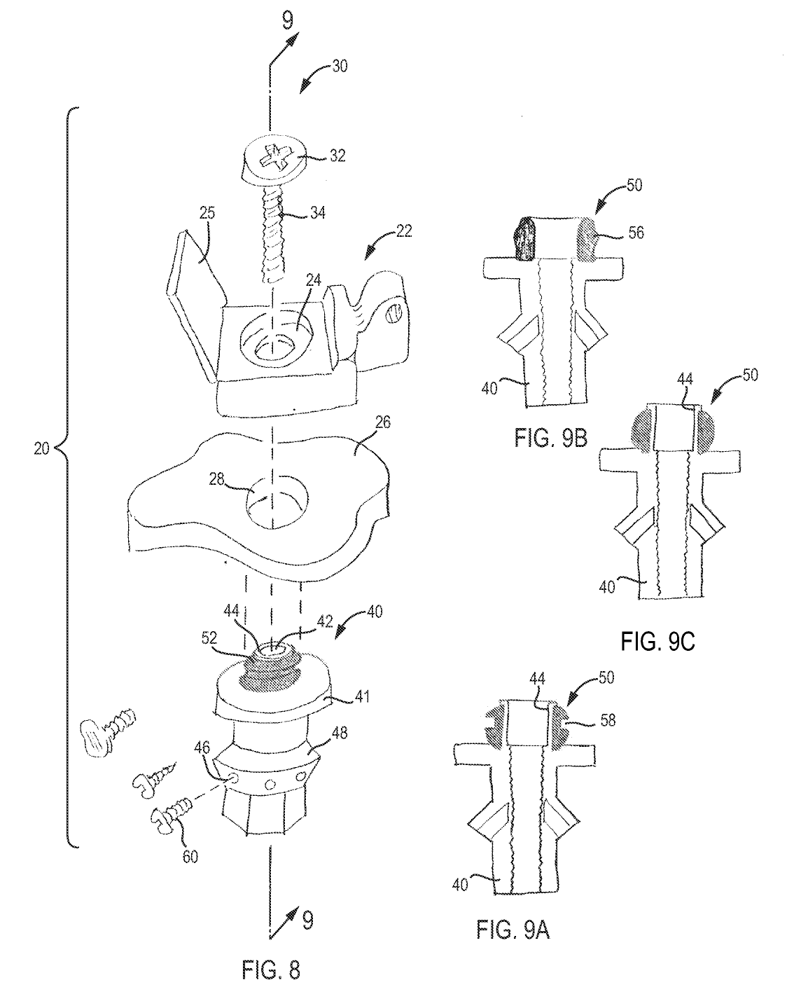

Referring now to FIGS. 8-9C, according to another illustrative embodiment, the bushing 50 may be a resilient member integrally formed with the nut 40. The nut 40 may include a projection 44 (e.g., ring, ridge, extension, collar, etc.) that extends from the upper flange 41 similar to the projection described above. The projection 44 surrounds the threaded opening 42 and has a diameter less than the diameter of the aperture 28. The bushing 50 is integrally formed around the projection 44, such as by a co-molding process. The bushing 50 may have an outer diameter that is slightly larger than the diameter of the aperture 28. As the nut 40 is inserted into the aperture 28, the bushing 50 is compressed to form an interference fit with the toilet bowl flange 26. Axis 9 generally defines the arrangement of the above components. Referring to FIGS. 9A-9C, the co-molded bushing 50 may include one or more outwardly extending ridges 56 or one or more grooves 58.

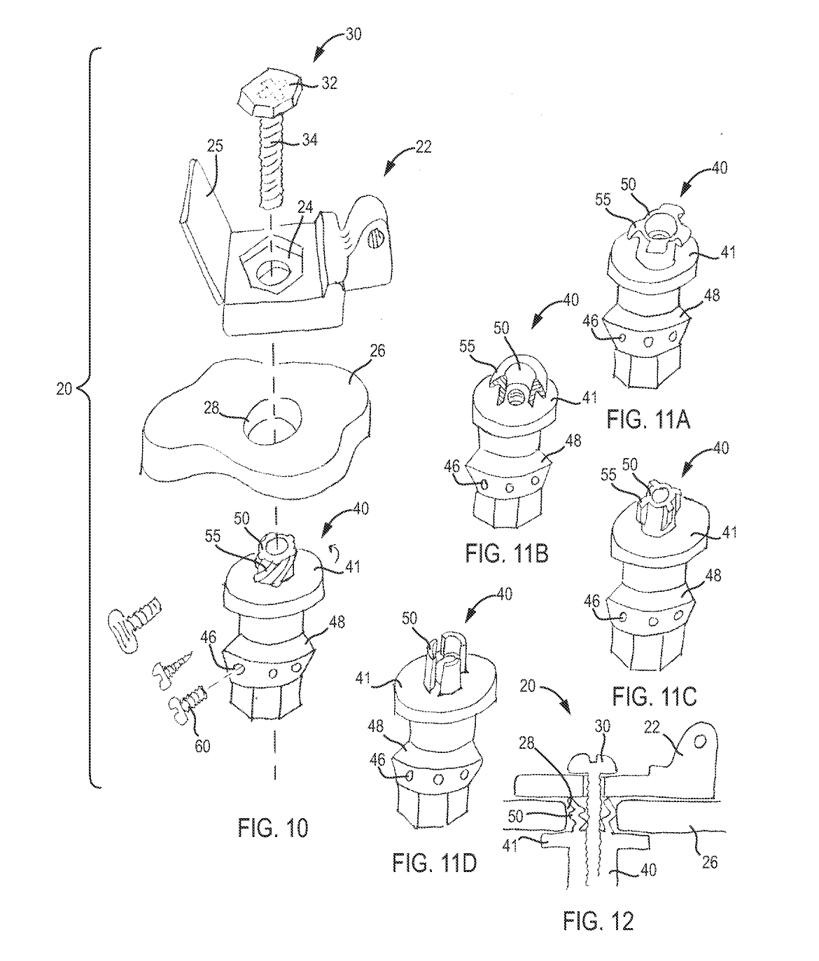

Referring now to FIGS. 10-12, according to another illustrative embodiment, the bushing 50 may be a rigid member integrally formed with the nut 40. The bushing 50 extends from the upper flange 41 and surrounds the threaded opening 42. The bushing 50 may include a main body with an outer diameter that is smaller than the diameter of the aperture 28 and outwardly extending projections 55 (e.g., collapsible elements, etc.) that are larger than the diameter of the aperture 28. As the nut 40 is inserted into the aperture 28, the projections 55 are compressed or otherwise distorted to form an interference fit with the toilet bowl flange 26. Referring to FIG. 10, in one embodiment the projections 55 may be large, coarse threads that spiral around the bushing 50. Referring to FIG. 11A, in another embodiment the projections 55 may be a multitude of horizontal tabs. Referring to FIG. 11B, in another embodiment the projections 55 may be a single, continuous flange. Referring to FIG. 11C, in another embodiment the projections 55 may be a multitude of vertical tabs. Referring to FIGS. 11D-12, in another embodiment, the bushing 50 may lack deformable projections 55. Instead, the main body of the bushing 50 may be configured to be crushed or deformed as the threaded connection between the bolt 30 and the nut 40 is tightened. As the bushing 50 is crushed, at least a portion of the bushing 50 contact the flange 26 around the aperture 28 and form an interference fit between the bushing 50 and the toilet bowl flange 26.

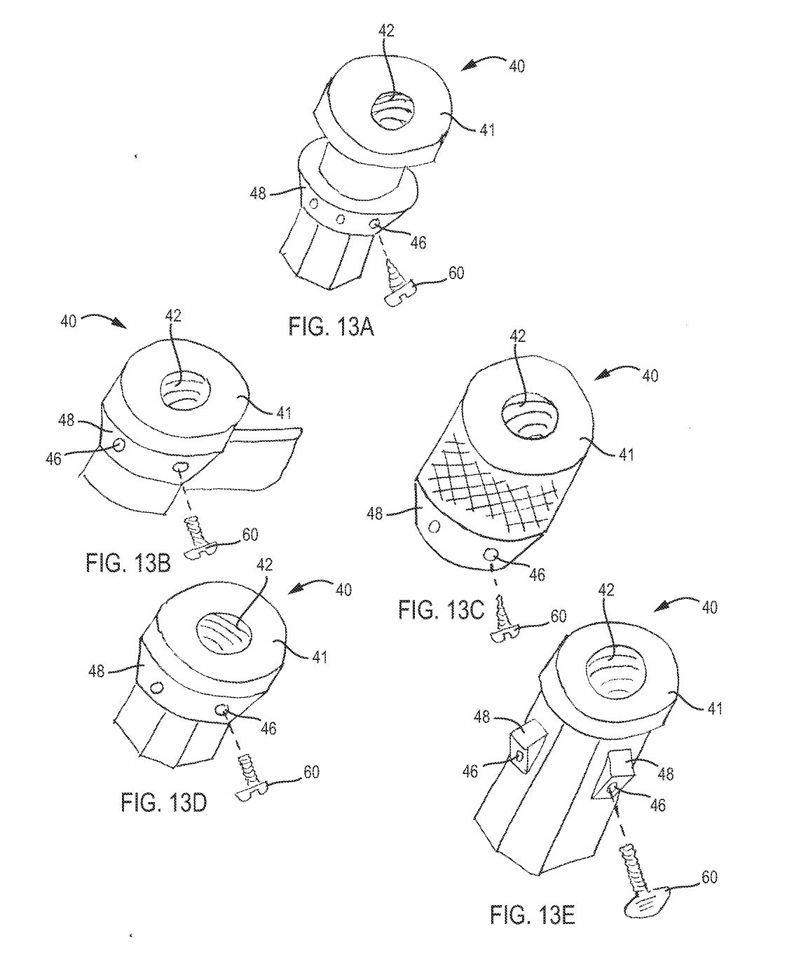

Referring now to FIGS. 13A-13E, the nut 40 is shown in more detail according to several illustrative embodiments. The nut 40 includes multiple (e.g. more than one) radial openings 46 (e.g., shafts, bores, holes, etc.). The radial openings 46 extend from the outer surface of the nut 40 to the threaded opening 42. The radial openings 46 may extend all the way through to the threaded opening 42 or may be separated from the threaded opening 42 by a thin wall 47 (see FIG. 4). The radial openings 46 may be threaded or non-threaded openings. A set screw 60 is received in one of the radial openings 46. After the apparatus 20 is installed (i.e., the nut 40 has engaged the bolt 30 and has been tightened), the set screw 60 is advanced into the radial opening 46 until it contacts the threaded end 34 of the bolt 30. The set screw 60 may contact the threaded end 34 directly or may compress the wall 47 against the threaded end 34. The contact between the set screw 60 and the threaded end 34 impedes the rotation of the bolt 30 and/or nut 40 and reduces the likelihood that the threaded connection between the bolt 30 and the nut 40 will loosen.

The radial openings 46 are inclined relative to the horizontal plane (i.e., the plane normal to the longitudinal axis of the threaded opening 42 when the nut 40 is installed). It may be difficult to install a set screw 60 in a horizontal radial opening, as there may be little clearance below the toilet bowl flange 26, making the use tools such as a screwdriver difficult. Inclined radial openings 46 therefore facilitate the installation of the set screw 60. Thus, in some embodiments, the radial openings 46 are inclined at an angle of from about 1° to about 60° relative to the longitudinal axis of the threaded opening.

By providing multiple radial openings 46 instead of a single radial opening 46 for the set screw 60, it is more likely that after the bolt 30 and the nut 40 have been tightened, one of the radial openings 46 will be directed away from the toilet bowl and easily accessible for the installation of the set screw 60.

The nut 40 is configured to have an increased cross-section around the radial openings 46. The increased cross-section gives more material for the threaded set screw 60 to engage, allowing a greater torque to be applied to the set screw 60. Referring to FIG. 13A-13D, in some embodiments the nut 40 may include radial openings 46 in a boss 48 that extends around the entirety of the nut 40. The nut 40 may have a reduced diameter between the boss 48 and the flange 41 (FIG. 13A). Referring to FIG. 13E, in other embodiments, the nut 40 may include separate bosses 48 for each of the radial openings 46.

According to one illustrative embodiment, the set screw 60 is a self-tapping set screw. In other illustrative embodiments, the set screw 60 may be any other suitable threaded member, such as a non-self-tapping screw, a bolt, a thumb screw.

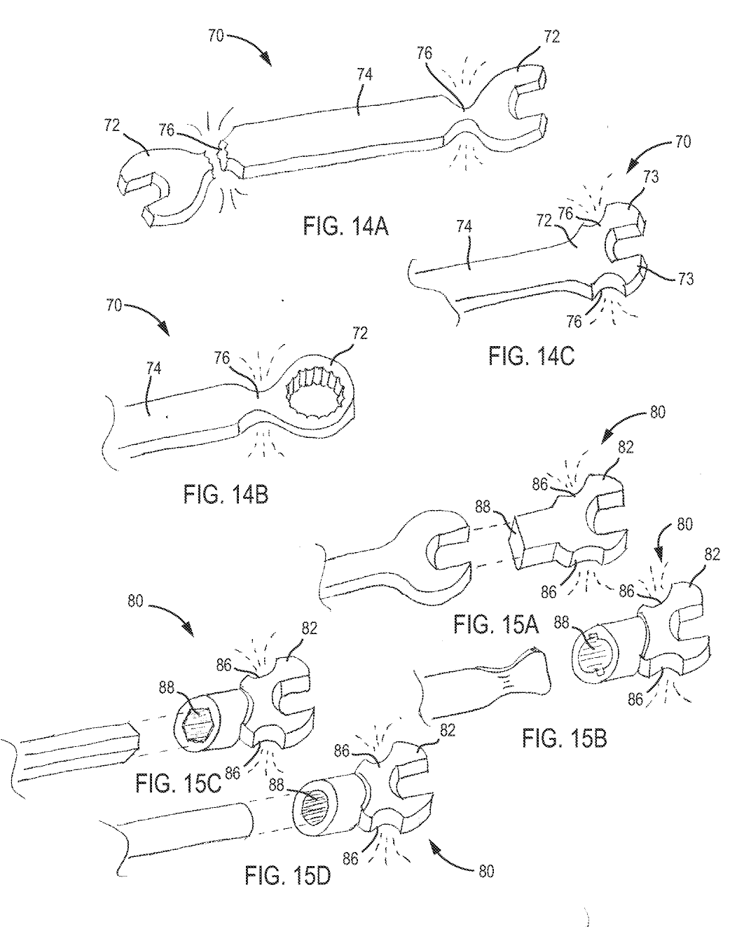

Referring now to FIGS. 14A-14C, a wrench 70 for tightening the fastening members for a toilet seat is shown according to an illustrative embodiment. The wrench 70 is configured to be a disposable tool with break-away ends 72. Referring to FIGS. 14A-14B, in some embodiments the ends 72 are coupled to a handle portion 74 by a frangible portion 76. The ends 72 may be closed ends or open ends. Referring to FIG. 14C, in another embodiment the end 72 may be an open end, with a frangible portion 76 at the base of each arm 73.

To properly fasten a toilet seat cover to the toilet, the threaded fasteners are generally configured to be tightened to a specified torque. The frangible portions 76 are configured to break once they have been used to apply a specified torque to the fastener. If the wrench has two ends 72, the wrench 70 may be used to tighten two fasteners to the pre-determined torque. Thus, in operation, the wrench is used to secure the nut, and one the pre-determined torque is attained, the frangible portion fractures and no further torque may be applied to the nut with the wrench.

According to one illustrative embodiment, the frangible portions 76 comprise portions of the handle 74 with a reduced cross-sectional area. In other embodiments, the frangible portions may be achieved through other means, such as scoring, chemical treatment, or the use of different materials.

According to an illustrative embodiment, the wrench 70 is formed from a polymer.

Referring now to FIGS. 15A-15D, a wrench 80 for tightening the fastening members for a toilet seat is shown according to another illustrative embodiment. Like the wrench 70 described above, the wrench 80 is configured to be a disposable tool including a break-away end 82 with frangible portions 86. The wrench 80 lacks a handle portion. Instead, the end 82 includes a coupling portion 88 that is configured to receive another tool or device (e.g., a conventional wrench, a hex key, a conventional screwdriver, a rod, etc.). By eliminating the handle portion, less disposable material is needed to form the wrench 80. The lack of a handle portion also reduces the size and weight of a packaged apparatus 20 including the wrench 80.

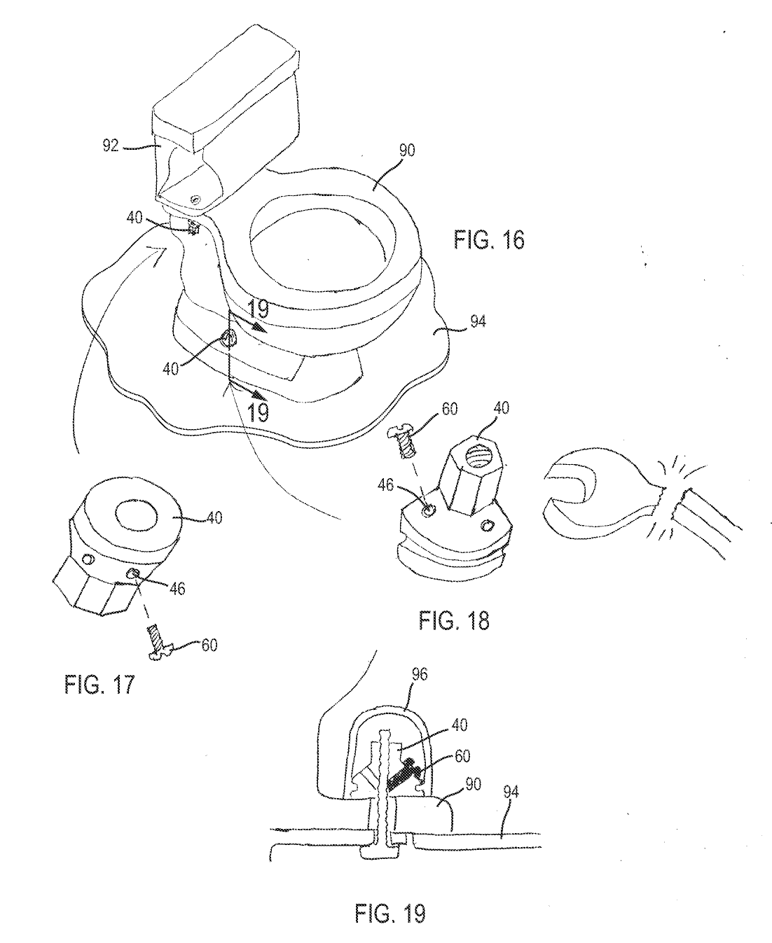

Referring now to FIGS. 16-19, while the features have been described in relation to an apparatus for coupling a toilet seat to a toilet, they may be used for other applications, particularly with regard to the nut having inclined radial openings and/or the wrench with frangible portions. Their use should not be limited to toilet applications. Referring to FIG. 17, according to one illustrative embodiment, a nut 40 with radial openings 46 for a set screw 60 may be utilized to couple a toilet bowl 90 to a toilet tank 92. Referring to FIGS. 16 and 18-19, according to another illustrative embodiment, a nut 40 with radial openings 46 for a set screw 60 may be utilized to couple the toilet bowl 90 to a floor 94. A decorative cap 96 may be provided to conceal the nut 40. Axis 19 generally defines the arrangement of the above components. A wrench with frangible portions (e.g., wrench 70 or wrench 80) may be utilized to tighten the nut 40 coupling the toilet bowl 90 to the toilet tank 92 or coupling the toilet bowl 90 to the floor 94 to a predetermined torque.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example is manifestly intended to be as broad as possible. For example, unless specifically otherwise noted a single particular element may also encompass a plurality of such particular elements. The invention should therefore not be limited by the above described embodiment, method, and examples, but by all embodiments and methods within the scope and spirit of the invention.

It is also important to note that the construction and arrangement of the elements of the system as shown in the illustrative embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited.

Further, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the illustrative embodiments without departing from the spirit of the present subject matter.

What is claimed is:

1. A fastening apparatus comprising:
a bolt;
proximal end comprising an upper flange;
a threaded shaft; and
a distal end;
a nut comprising:
a proximal end, a distal end, and a shaft, the shaft comprising:
threaded bore extending longitudinally in the shaft at least a portion of the distance from the proximal end to the distal end; and the threaded bore is configured to receive the thread shaft of the bolt;
an outer surface; and
a plurality of radial bores extending through the shaft from the outer surface to the inner threaded bore, each of the radial openings disposed at an angle of less than 90° relative to the shaft of the nut, the angle defined by the distal end of the shaft of the nut, the shaft of the nut, and the radial opening; and
a set screw; wherein the set screw is configured to be received in one of the radial openings.

2. The apparatus of claim 1, wherein the set screw is one of a self-tapping screw, a non-self-tapping screw, a bolt, or a thumbscrew.

3. A mounting apparatus for coupling a toilet seat hinge to a toilet flange, the mounting apparatus comprising:
a bolt;
proximal end comprising an upper flange;
a threaded shaft; and
a distal end;
a nut comprising:
a proximal end, a distal end, and a shaft, the shaft comprising:
threaded bore extending longitudinally in the shaft at least a portion of the distance from the proximal end to the distal end; and the threaded bore is configured to receive the thread shaft of the bolt;
an outer surface; and
a plurality of radial bores extending through the shaft from the outer surface to the inner threaded bore, each of the radial openings disposed at an angle of less than 90° relative to the shaft of the nut, the angle defined by the distal end of the shaft of the nut, the shaft of the nut, and the radial opening; and
a set screw; wherein the set screw is configured to be received in one of the radial openings.

4. A mounting apparatus for coupling a toilet seat hinge to a toilet flange, the mounting apparatus comprising:
a bolt comprising:
proximal end comprising an upper flange; and
threaded distal end;
a nut comprising a threaded opening; and
a bushing disposed in an opening in the toilet flange; wherein the bushing forms an interference fit with the toilet flange.

5. The mounting apparatus of claim 4, wherein the bushing is a resilient member.

6. The mounting apparatus of claim 4, wherein the bushing is integrally formed with the nut.

7. The mounting apparatus of claim 4, wherein the outer diameter of the bushing expands as the bushing is compressed by the nut.

8. A method for coupling a toilet seat hinge to a toilet flange comprising an aperture, the method comprising:
providing a bolt on one side of the toilet flange such that the bolt extends through the aperture, the bolt comprising a threaded end;
providing a nut on the side of the toilet flange opposite of the bolt, the nut comprising a proximal end comprising a head, a distal end, and at least one opening for a set screw;
engaging the nut with the bolt such that toilet seat hinge is between the bolt and the toilet flange; and
providing a set screw in the opening, the set screw providing a pressure on the threaded end of the bolt.

9. The method of claim 8 further comprising:
providing a bushing in an opening in the toilet flange; and
forming an interference fit between the bushing and the toilet flange by tightening the nut to deform the bushing.

10. The mounting apparatus of claim 8, wherein the at least one opening for a set screw is at an angle of less than 90°, the angle defined by distal end of the nut, the proximal end of the nut, and a longitudinal axis of the opening for the set screw.
